(19) United States
(12) Patent Application Publication
(10) Pub. No.: US 2008/0175700 A1
(43) Pub. Date: Jul. 24, 2008

(54) QUICK RELEASE FORK ATTACHMENT

(75) Inventors: Barry McGrane, County Louth (IE); Kevin Turnbull, County Louth (IE)

Correspondence Address: HOLLAND & KNIGHT LLP, 10 ST. JAMES AVENUE, 11th Floor, BOSTON, MA, 02116-3889, US

(73) Assignee: Moffett Research and Development Limited

(21) Appl. No.: 11/626,537

(22) Filed: Jan. 24, 2007

(51) Int. Cl. B66F 19/00

(52) U.S. Cl. 414/607; 414/785

(57) ABSTRACT

This invention relates to a quick release fork attachment for a forklift truck having a fork attachment carriage. The quick release fork attachment comprises an L-shaped fork with a pair of hooks protruding rearwardly therefrom. One of the hooks is pivotally mounted on the L-shaped fork to and from and open position and a closed position. There is provided a locking mechanism to releasably secure the pivotably mounted hook in a closed position. In this way, quick placement and removal of the quick release fork attachment to and from the fork attachment carriage is facilitated.

### FIELD OF THE INVENTION

This invention relates to a quick release fork attachment for a forklift truck.

### BACKGROUND OF THE INVENTION

Forklift trucks have been used for many years to handle goods in or around warehouses, factories, building sites and the like. These forklift trucks greatly facilitate the manoeuvring of goods. Generally speaking, the forklift trucks are provided with a fork attachment comprising one or a pair of forks which are used to lift and subsequently move the goods. There is, however, a problem with the known types of fork attachments. Typically, the fork attachments have forks that are of a fixed length and are only suitable for manoeuvring certain types of goods. It is not uncommon for the forklift to be used in an environment in which it must manoeuvre goods of varying shapes and sizes and in order to safely manoeuvre the goods, it may be necessary to provide several different fork attachments with forks of different lengths. For example, a forklift used in the construction industry may be required to deliver large wall panels requiring 120″ forks for a large portion of its time and may also be required to deliver lumber for a significant portion of the time which may require standard length, 40″ forks. It is therefore necessary to provide a forklift attachment that will be able to handle both requirements without requiring the decommissioning of the forklift for a significant period of time while a different set of forks are mounted on the forklift truck.

One type of forklift where this becomes particularly significant is the truck mounted forklift, otherwise commonly referred to as a “piggyback” forklift truck. A typical example of such a forklift is that disclosed in GB Patent Specification No. 2,259,292 (Moffett Research & Development Limited). These piggyback forklift trucks are transported on the rear of a carrying vehicle or articulated chassis to the premises of customers where they are used to load or unload goods onto or from the trailer bed. It is often the case that the exact size and shape of the goods to be loaded onto a trailer are not known until the piggyback forklift truck operator arrives at the customers premises and only at that stage may they determine the appropriate sized forks for use in that particular job. If goods of varying sizes requiring different sized forks must be loaded or unloaded, it is desirable to be able to provide the appropriately sized forks with the minimum difficulty and time.

Heretofore, various solutions have been proposed including providing extendable forks such as those disclosed in U.S. Pat. No. 4,498,837 (Kooi et al). However, there are various problems with providing the extendable forks and by and large these are unsuitable for use with particularly heavy goods. Furthermore, generally speaking, the additional reach provided by such extendable forks is relatively limited and in many cases is insufficient. Another solution is to provide separate pairs of forks to suit the particular requirements. One significant disadvantage of this method is that typically considerable time and effort must be spent in removing one set of forks from the fork attachment carriage and substituting a different set of forks in their place, before loading or unloading may commence. This is particularly significant in circumstances where the operator of the forklift truck wishes to move a variety of different size and shaped goods, requiring multiple changes of fork attachments, as is often the case.

### SUMMARY OF THE INVENTION

This invention relates to a quick release fork attachment for a forklift truck having a fork attachment carriage, the quick release fork attachment comprising:
an L-shaped fork having an upright portion and a tine, the tine protruding outwardly from a lower end of the upright portion;
the upright portion having a pair of hooks protruding outwardly therefrom, in the opposite direction to the tine, for mounting the fork on the carriage, one of the hooks being pivotably mounted on the upright portion and pivotable to and from an open position suitable to receive and release the carriage and a closed position suitable to engage the carriage; and
a locking mechanism for releasably securing the pivotably mounted hook in a closed position.

By having such a quick release fork attachment, it will be possible for an operator of a forklift truck to quickly remove the fork attachment from a carriage and subsequently attach a different fork attachment to the carriage. In this way, it will be possible for the operator of the forklift truck to interchange one or a pair of forks on the forklift truck in a relatively quick and expedient manner that does not require the forklift to be out of commission for a significant period of time.

In one embodiment of the invention, the fork attachment further comprises a carrier bracket, the upright portion of the fork being connected to the carrier bracket and the carrier bracket having the pair of hooks for mounting the fork on the carriage, mounted thereon. It is envisaged that one of the pair of hooks may be located adjacent the upper end of the upright portion and the other of the pair of hooks may be located adjacent the lower end of the upright portion. Preferably, the hook located adjacent the lower end of the upright portion is the pivotably mounted hook. This will facilitate mounting and dismounting of the fork attachment from the fork attachment carriage.

In another embodiment of the invention, the hooks each comprise a jaw portion defining an open mouth for reception of the carriage therein. Preferably, the hooks are arranged with the open mouths of the hooks facing each other. In a further embodiment of the invention, the locking mechanism further comprises a locking pin. It is envisaged that the pivotably mounted hook and the portion of the quick release fork attachment upon which the pivotably mounted hook is mounted each define a through-bore for reception of the locking pin. This is seen as a particularly simple arrangement that will facilitate quick and efficient changing of fork attachments.

The details of one or more implementations are set forth in the accompanying drawings and the description below. Other features and advantages will become apparent from the description, the drawings, and the claims.

### BRIEF DESCRIPTION OF THE DRAWINGS

The invention will be more clearly understood from the following description of some embodiments thereof, given by way of example only, with reference to the accompanying drawings, in which:

FIG. 1 is a perspective view of a forklift truck mounting a quick release fork attachment according to the invention;

FIG. 2 is a perspective view of the quick release fork attachment;

FIG. 3 is a rear perspective view of the quick release fork attachment;

FIG. 4 is a perspective view of the fork attachment being mounted on a fork carriage;

FIG. 5 is a side view of the fork attachment being mounted on a fork carriage;

FIG. 6 is a rear perspective view of the fork attachment mounted on a fork carriage with the pivotably mounted hook in an open position;

FIG. 7 is a rear perspective view of the fork attachment mounted on a fork carriage with the pivotably mounted hook in a closed position;

FIG. 8 is a rear perspective view of the fork attachment stowed on an articulated chassis; and

FIG. 9 is a rear perspective view of an alternative embodiment of fork attachment according to the invention.

### DETAILED DESCRIPTION OF THE INVENTION

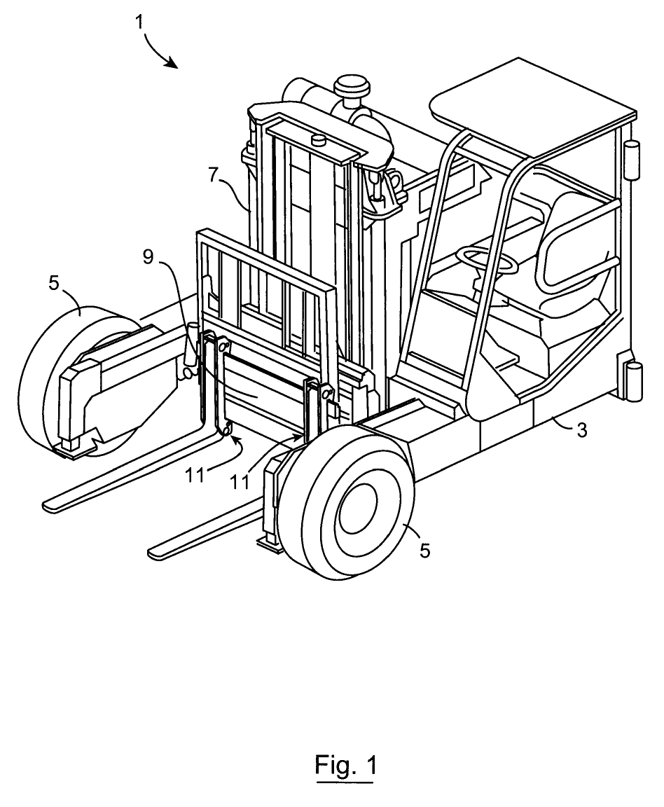

Referring to the drawings and initially to FIG. 1 thereof, there is shown a perspective view of a forklift truck, indicated generally by the reference numeral 1 comprising a chassis 3 mounting ground engaging wheels 5 and having lifting means provided by way of an upright mast 7 mounted on the chassis 3. The upright mast 7 carries a fork attachment carriage 9 which is movable up and down the upright mast 7. The fork attachment carriage 9 in turn mounts the quick release fork attachment 11.

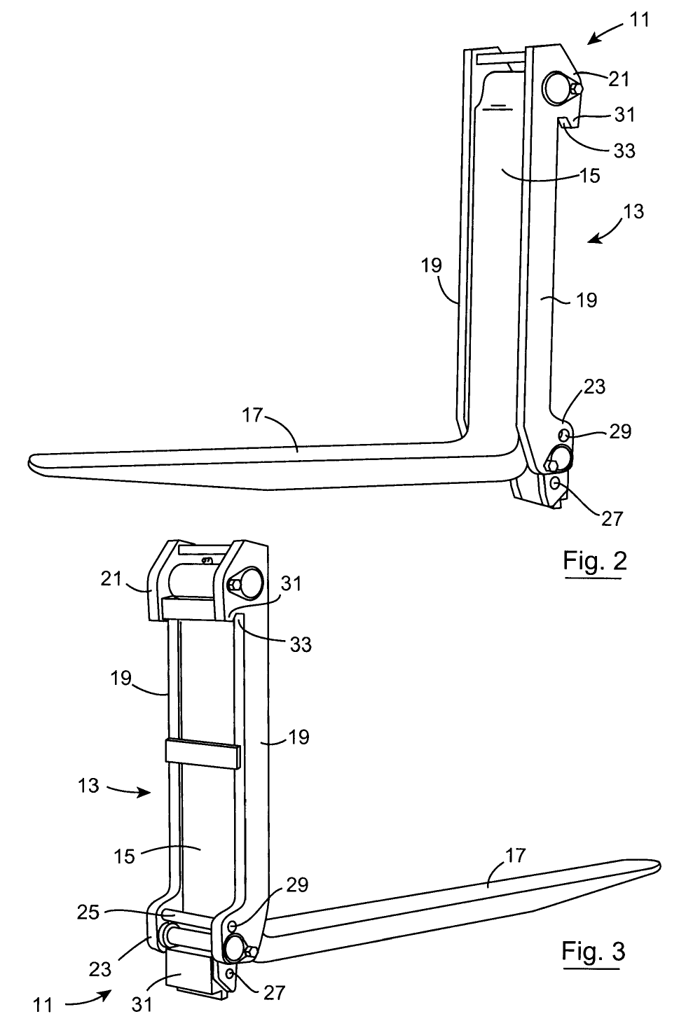

Referring now to FIGS. 2 and 3, there is shown a quick release fork attachment 11 comprising an L-shaped fork 13 having an upright portion 15 and a tine 17 protruding outwardly from a lower end of the upright portion 15. The fork attachment 11 further comprises a carrier bracket 19 connected to the upright portion of the fork 13. A pair of hooks 21, 23 are mounted on the carrier bracket 19 and protrude outwardly therefrom in the opposite direction to the tine 17. One of the hooks 23 is pivotably mounted on the carrier bracket 19 and pivotable to and from an open position, as shown, suitable to receive and release the fork attachment carriage, and a closed position suitable to engage the carriage. A locking mechanism, provided by way of a locking pin 25, is provided for releasably securing the pivotably mounted hook 23 in a closed position. Both the pivotably mounted hook 23 and the carrier bracket 19 each define a through bore 27 and 29 respectively, for reception of the locking pin 25. One of the pair of hooks 21, 23 is located adjacent the upper end of the upright portion and the other of the pair of hooks is located adjacent the lower end of the upright portion. In the embodiment shown, the hook located adjacent the lower end of the upright portion is the pivotably mounted hook 23. Each of the hooks further comprises a jaw portion 31 defining an open mouth 33 for reception of the carriage therein. The hooks 21, 23 are arranged on the carrier bracket with the open mouth 33 of the hooks facing each other.

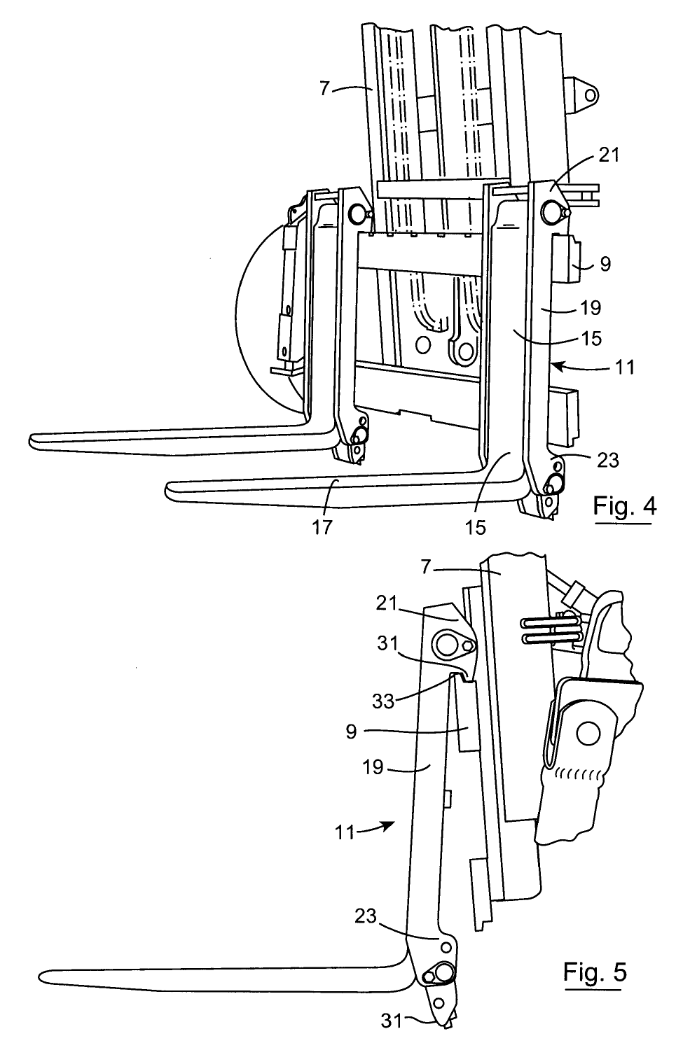

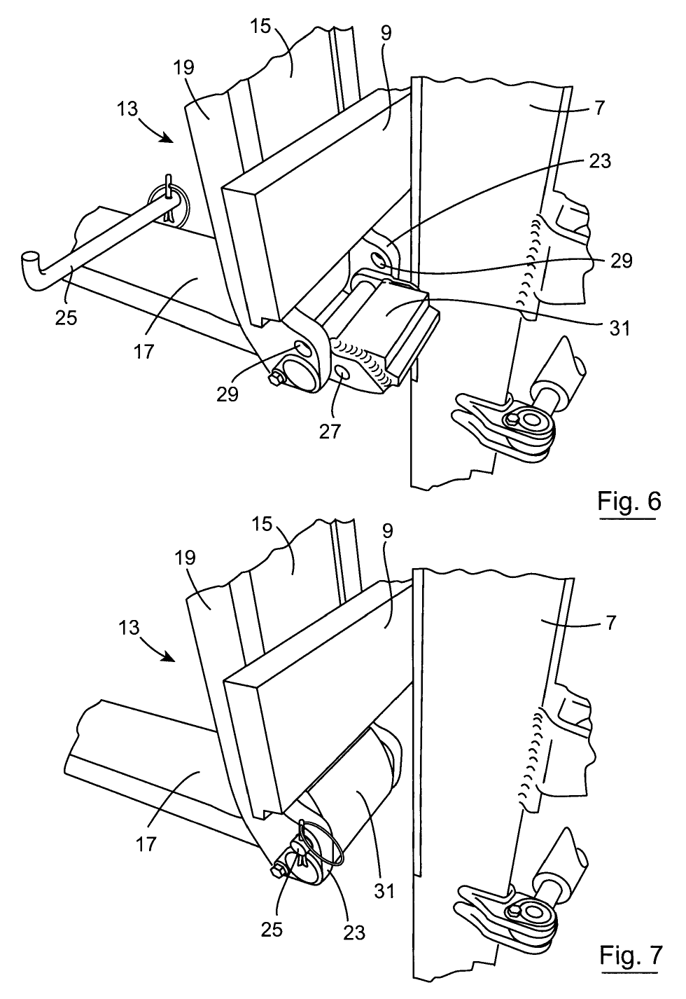

Referring now to FIGS. 4 to 7 inclusive, the manner of mounting the quick release fork attachment onto a fork attaching carriage will be described in more detail. In order to engage the fork attachment, the operator of the forklift truck 1 lowers the fork attachment carriage below the height of the hook 21 located adjacent the upper end of the upright portion. The operator of the forklift then tilts the upright mast 7 forwards and manoeuvres the forklift and fork attachment carriage so that the fork attachment carriage 9 engages the hook 21 (FIG. 4, 5). The operator then raises the fork attachment carriage 9 on the upright mast 7 thereby lifting the fork attachment upwards free of the ground, and subsequently tilts the mast backwards once again until the mast is in a substantially vertical configuration. By doing so, the lower end of the upright portion and hence the pivotably mounted hook 23 will be brought into close proximity to the fork attachment carriage. Once in this position (FIG. 6), the hook 23 may be pivoted from an open position to a closed position and the locking pin 25 inserted through the through bores 27, 29, thereby locking the hook 23 in a closed position (FIG. 7). The fork attachment is now in position and ready for use.

In order to release the fork attachment 11 and replace the fork attachment with a different fork attachment, for example, one with shorter tines, the above steps are essentially reversed. The operator of the forklift truck 1 brings the mast into either an upright or rearwardly tilted position and releases the locking pin 25 from the through bores 27, 29. The mast is then tilted forwards and the fork attachment carriage 9 is lowered until the fork attachment carriage 9 is free of the hook 21. The forklift truck 1 is then reversed away from the fork attachment 11 and brought into engagement with a different fork attachment in the manner described previously.

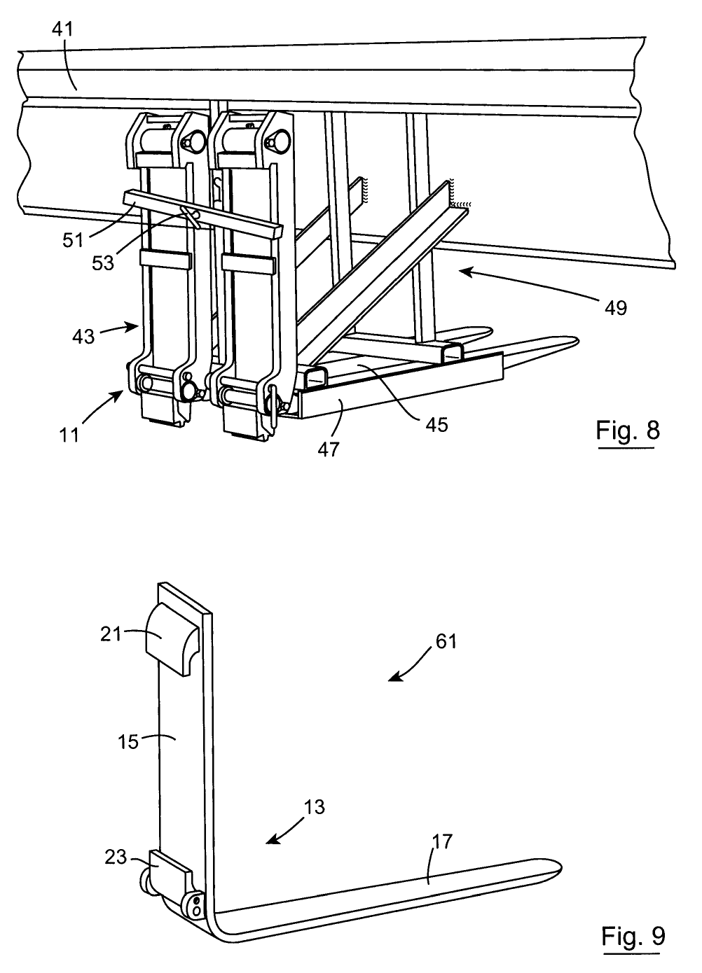

Referring to FIG. 8 of the drawings, there is shown a mounting arrangement for the quick release fork attachment 11 on an articulated chassis 41. This is seen as particularly suitable for the quick release fork attachments used in conjunction with piggyback forklift trucks. The mounting arrangement 43 in turn comprises a pair of sockets 45, 47 suspended by way of a framework 49 below the articulated chassis trailer 41. A locking bar 51 and a locking screw 53 are provided to secure the quick release fork attachment 11 in position on the trailer ready for transport.

Referring to FIG. 9 of the drawings, there is shown a rear perspective view of an alternative configuration of fork attachment according to the invention, indicated generally by the reference numeral 61, where like parts have been given the same reference numerals as before. The quick-release fork attachment comprises an L-shaped fork 13 having an upright portion 15 and a tine 17 protruding outwardly from a lower end of the upright portion 15. The fork attachment further comprises a pair of hooks 21, 23 mounted on the upright portion 15 and protruding outwardly therefrom in the opposite direction to the tine. One of the hooks 23 is pivotably mounted on the upright portion and is pivotable to and from an open position suitable to receive and release the fork attachment carriage (not shown) and a closed position suitable to engage the carriage. Essentially therefore, the hooks are mounted directly onto the rear of the upright portion of the fork as opposed to on a bracket.

It is envisaged that a number of different shapes and sizes of quick release fork attachment may be provided, including a single fork or a pair of forks, as shown. Ideally, forks with tines of varying lengths may be provided. It is envisaged that more than one quick release fork attachment may be provided so that a selection of forks may be used by the operator of the forklift vehicle. Furthermore, it is envisaged that although in the embodiment shown, each of the forks has a carrier bracket mounting the hooks, the hooks could also be mounted directly onto the upright of the forks themselves. Furthermore, in the embodiment shown, a locking pin with a split ring is shown for securing the pivotably mounted hook in a closed position, however, it will be understood that other locking mechanism could also be employed to equal effect. What is important is that the locking mechanism is relatively simple and inexpensive to provide.

In this specification, the terms “comprise, comprises, comprised and comprising” and the terms “include, includes, included and including” are deemed totally interchangeable and should be afforded the widest possible interpretation.

The invention is in no way limited to the embodiment hereinbefore described but may be varied in both construction and detail within the scope of the claims.

1. A quick release fork attachment for a forklift truck having a fork attachment carriage, the quick release fork attachment comprising:
an L-shaped fork having an upright portion and a tine, the tine protruding outwardly from a lower end of the upright portion;
the upright portion having a pair of hooks protruding outwardly therefrom, in the opposite direction to the tine, for mounting the fork on the carriage, one of the hooks being pivotably mounted on the upright portion and pivotable to and from an open position suitable to receive and release the carriage and a closed position suitable to engage the carriage; and
a locking mechanism for releasably securing the pivotably mounted hook in a closed position.

2. The quick release fork attachment as claimed in claim 1 in which the fork attachment further comprises a carrier bracket, the upright portion of the fork being connected to the carrier bracket and the carrier bracket having the pair of hooks for mounting the fork on the carriage, mounted thereon.

3. The quick release fork attachment as claimed in claim 1 in which one of the pair of hooks is located adjacent the upper end of the upright portion and the other of the pair of hooks is located adjacent the lower end of the upright portion.

4. The quick release fork attachment as claimed in claim 3 in which the hook located adjacent the lower end of the upright portion is the pivotably mounted hook.

5. The quick release fork attachment as claimed in claim 1 in which the hooks each comprise a jaw portion defining an open mouth for reception of the carriage therein.

6. The quick release fork attachment as claimed in claim 5 in which the hooks are arranged with the open mouths of the hooks facing each other.

7. The quick release fork attachment as claimed in claim 1 in which the locking mechanism further comprises a locking pin.

8. The quick release fork attachment as claimed in claim 7 in which the pivotably mounted hook and the portion of the quick release fork attachment upon which the pivotably mounted hook is mounted each define a through bore for reception of the locking pin.

9. A quick release fork attachment for a forklift truck having a fork attachment carriage, the quick release fork attachment comprising:
an L-shaped fork having an upright portion and a tine, the tine protruding outwardly from a lower end of the upright portion;
the L-shaped fork further comprises a carrier bracket, the upright portion of the fork being connected to the carrier bracket;
the carrier bracket having a pair of hooks protruding outwardly therefrom, in the opposite direction to the tine, for mounting the fork on the carriage, one of the hooks being pivotably mounted on the carrier bracket and pivotable to and from an open position suitable to receive and release the carriage and a closed position suitable to engage the carriage; and
a locking mechanism for releasably securing the pivotably mounted hook in a closed position.

10. The quick release fork attachment as claimed in claim 9 in which one of the pair of hooks is located adjacent the upper end of the upright portion and the other of the pair of hooks is located adjacent the lower end of the upright portion.

11. The quick release fork attachment as claimed in claim 10 in which the hook located adjacent the lower end of the upright portion is the pivotably mounted hook.

12. The quick release fork attachment as claimed in claim 9 in which the hooks each comprise a jaw portion defining an open mouth for reception of the carriage therein.

13. The quick release fork attachment as claimed in claim 12 in which the hooks are arranged with the open mouths of the hooks facing each other.

14. The quick release fork attachment as claimed in claim 9 in which the locking mechanism further comprises a locking pin and in which the pivotably mounted hook and the portion of the quick release fork attachment upon which the pivotably mounted hook is mounted each define a through bore for reception of the locking pin.

15. A quick release fork attachment for a forklift truck having a fork attachment carriage, the quick release fork attachment comprising:
an L-shaped fork having an upright portion and a tine, the tine protruding outwardly from a lower end of the upright portion;
the upright portion having a pair of hooks protruding outwardly therefrom, in the opposite direction to the tine, for mounting the fork on the carriage, one of the hooks being pivotably mounted on the upright portion and pivotable to and from an open position suitable to receive and release the carriage and a closed position suitable to engage the carriage;
one of the pair of hooks is located adjacent the upper end of the upright portion and the other of the pair of hooks is located adjacent the lower end of the upright portion, the hook located adjacent the lower end of the upright portion is the pivotably mounted hook; and
a locking mechanism for releasably securing the pivotably mounted hook in a closed position.

16. The quick release fork attachment as claimed in claim 15 in which the fork attachment further comprises a carrier bracket, the upright portion of the fork being connected to the carrier bracket and the carrier bracket having the pair of hooks for mounting the fork on the carriage, mounted thereon.

17. The quick release fork attachment as claimed in claim 15 in which the hooks each comprise a jaw portion defining an open mouth for reception of the carriage therein.

18. The quick release fork attachment as claimed in claim 17 in which the hooks are arranged with the open mouths of the hooks facing each other.

19. The quick release fork attachment as claimed in claim 15 in which the locking mechanism further comprises a locking pin.

20. The quick release fork attachment as claimed in claim 19 in which the pivotably mounted hook and the portion of the quick release fork attachment upon which the pivotably mounted hook is mounted each define a through bore for reception of the locking pin.
